(19) United States
(12) Patent Application Publication
(10) Pub. No.: US 2025/0320130 A1
(43) Pub. Date: Oct. 16, 2025

(54) Copper Oxide-Containing Powder, Conductive Paste, and Method for Producing Copper Oxide-Containing Powder

(71) Applicant: JX Metals Corporation, Tokyo (JP)

(72) Inventors: Hironori Orikasa, Ibaraki (JP); Masashi Kumagai, Tokyo (JP)

(21) Appl. No.: 18/561,035

(22) PCT Filed: Feb. 18, 2022
(86) PCT No.: PCT/JP2022/006771

§ 371 Date: May 17, 2024

(30) Foreign Application Priority Data
Jun. 15, 2021 (JP) 2021-099723

(51) Int. Cl. C01G 3/02; H01B 1/22

(52) U.S. Cl. CPC C01G 3/02; H01B 1/22; C01P 2004/01; C01P 2004/61; C01P 2004/62; C01P 2006/12; C01P 2006/40

(57) ABSTRACT

A copper oxide-containing powder containing copper (I) oxide, wherein, when the copper oxide-containing powder is subjected to a heat treatment to 400° C., the copper oxide-containing powder comprises pyrolysis residues derived from pitch, in a mass ratio to copper (I) oxide of 0.025 to 0.060%.

### TECHNICAL FIELD

This specification discloses arts relating to a copper oxide-containing powder, a conductive paste, and a method for producing a copper oxide-containing powder.

### BACKGROUND ART

Metal powders may be dispersed and included in conductive pastes and used in the production of low-temperature co-fired ceramic (LTCC) substrates and multilayer ceramic chip capacitors (MLCCs). In the LTCC substrates, the metal powders are sintered by firing to form metal wiring between ceramic layers.

As a material for the metal wiring, copper is desirable because it is less expensive than silver or platinum and is also considered to have less migration. On the other hand, copper is more easily oxidized than silver or platinum. In particular, fine copper powder used in conductive pastes has a large surface area, so that the suppression of its oxidation is required. There is concern that the oxidation of the copper powder may reduce not only the quality of the conductive paste itself containing the copper powder, but also the quality and yield of the products produced using the conductive paste.

To prevent the oxidation of the copper powder, a surface treatment with an antioxidant may be applied to the copper powder. Japanese Patent Application Publication No. 2017-122252 A (Patent Literature 1) describes “a surface-treated copper powder comprising one or more elements selected from the group consisting of zirconium, lanthanum, and yttrium being present on the surface of the copper powder, wherein the surface-treated copper powder has an oxygen content of 1% by mass or less”, as a surface-treated copper powder that can suppress oxidation of copper powder and increase the sintering start temperature.

### CITATION LIST

### Patent Literature

[PTL 1]

Japanese Patent Application Publication No. 2017-122252 A

### SUMMARY OF INVENTION

### Technical Problem

However, when copper powder that has been surface-treated with an antioxidant is heated and sintered for metal wiring applications as described above, solid carbon may be produced due to pyrolysis of an organic substance(s) in the antioxidant. The carbon derived from the antioxidant is present on the surfaces of the copper particles and inhibits contact and sintering between the copper particles.

To avoid this, it is considered that the copper powder is heated in an oxidizing atmosphere to oxidize and remove the carbon, and the atmosphere is then switched to a reducing atmosphere to heat the copper powder again. However, the heating that requires such an atmosphere switching requires an explosion-proof facility that can achieve the switching and safely realize the reducing atmosphere using hydrogen or the like.

This specification discloses a copper oxide-containing powder, a conductive paste, and a method for producing a copper oxide-containing powder, which have an improved antioxidant ability and can effectively form a copper sintered body by heating in a non-reducing atmosphere.

### Solution to Problem

One copper oxide-containing powder disclosed in this specification comprises copper (I) oxide, wherein, when the copper oxide-containing powder is subjected to a heat treatment to 400° C., the copper oxide-containing powder comprises pyrolysis residues derived from pitch, in a mass ratio to copper (I) oxide of 0.025 to 0.060%.

Other copper oxide-containing powder disclosed in this specification comprises copper (II) oxide, wherein, when the copper oxide-containing powder is subjected to a heat treatment to 400° C., the copper oxide-containing powder comprises pyrolysis residues derived from pitch, in a mass ratio to copper (II) oxide of 0.050 to 0.120%.

The conductive paste disclosed in this specification comprises the copper oxide-containing powder as described above, a binder resin, and a solvent.

The method for producing a copper oxide-containing powder disclosed in this specification is a method for producing a copper oxide-containing powder comprising pyrolysis residues derived from pitch, the method comprising the steps of: preparing a copper oxide powder, and at least one of pitch and at least one organic substance for generating the pitch by a heat treatment; mixing the copper oxide powder with at least one of the pitch and the organic substance to obtain a pre-heating powder; and subjecting the pre-heating powder to a heat treatment to 400° C. to obtain a copper oxide-containing powder comprising pyrolysis residues derived from the pitch.

### Advantageous Effects of Invention

According to the copper oxide-containing powder, the conductive paste, and the method for producing a copper oxide-containing powder as described above, it is possible to have an improved antioxidant ability and effectively form a copper sintered body by heating in a non-reducing atmosphere.

### BRIEF DESCRIPTION OF DRAWINGS

FIG. 1 is a graph showing changes of masses with temperature increase obtained by thermogravimetric measurements of Comparative Example 1 and Examples 1 to 5.

FIG. 2 is a graph showing changes of linear contractions with temperature increase obtained by thermomechanical analysis of Comparative Example 1 and Examples 1 to 5.

FIG. 3 is a photograph of a pellet of Example 4.

FIG. 4 is a graph showing changes of masses with temperature increase obtained by thermogravimetric measurements of Reference Example and Examples 3 to 5.

FIG. 5 is a graph obtained by subtracting masses of volatile components of pitch from the graph of FIG. 4.

### DESCRIPTION OF EMBODIMENTS

Embodiments of the copper oxide-containing powder, the conductive paste, and the method for producing the copper oxide-containing powder as described above will be described below in detail.

A copper oxide-containing powder according to an embodiment contains copper (I) oxide, wherein, when the copper oxide-containing powder is subjected to a heat treatment to 400° C., the copper oxide-containing powder includes pyrolysis residues derived from pitch, in a mass ratio to copper (I) oxide of 0.025 to 0.060%.

When the copper oxide-containing powder is heat-treated to 400° C., high-boiling point components contained in the pitch and volatile substances produced by pyrolysis of the pitch are dispersed, and at the same time, pyrolysis residues are produced. A part of the volatile substances and the residues contains reducing components such as carbon and hydrogen, which react with copper oxide to reduce copper oxide to metal copper. The pyrolysis residues utilized for the reduction of copper oxide is converted to carbon monoxide, carbon dioxide, or water and disappears while the conversion of copper oxide to metal copper proceeds. Here, if the pitch-derived pyrolysis residues contained in the above copper oxide-containing powder when it is heat-treated at 400° C. is in the predetermined range as described below with respect to copper oxide, the copper oxide is sufficiently reduced to metal copper, and the above pyrolysis residues are converted to gases such as carbon dioxide and carbon monoxide, almost all of which disappear. As a result, the copper sintered body can also be obtained, for example, by heating in a non-reducing atmosphere with an inert gas. Further, such a copper sintered body can have low electrical resistance because the carbonaceous components are sufficiently removed.

### (Copper Oxide)

The copper oxide-containing powder may be any powder containing copper (I) oxide (Cu₂O, so-called cuprous oxide) and/or copper (II) oxide (CuO). The copper oxide-containing powder contains at least one of copper (I) oxide and copper (II) oxide. If it contains copper (I) oxide and/or copper (II) oxide, as described above, the copper oxide is reduced to metal copper by the reducing components contained in the pitch by heating, so that the copper sintered body is obtained.

The copper oxide-containing powder may include a copper oxide powder consisting essentially of copper oxide particles. As used herein, a powder containing copper (I) oxide is referred to as a copper (I) oxide powder, and a powder containing copper (II) oxide is referred to as a copper (II) oxide powder. The copper (I) oxide powder may further contain copper (II) oxide, and the copper (II) oxide powder may further contain copper (I) oxide. It should be noted that when the copper (I) oxide powder and the copper (II) oxide powder, and copper (I) oxide and copper (II) oxide are not distinguished, they may be simply referred to as a copper oxide powder and copper oxide, respectively. Further, the copper oxide-containing powder may include a copper powder containing copper oxide, more specifically, a copper powder composed of copper particles whose surfaces are coated with copper oxide such as copper (I) oxide. Whether or not the copper oxide-containing powder contains the copper oxide powder or the copper powder containing copper oxide can be confirmed by X-ray diffractometry (XRD).

### (Pitch)

The copper oxide-containing powder is a mixture of the above copper oxide powder or copper powder containing copper oxide with pitch or at least one organic substance that produces the pitch through a heat treatment. When such a copper oxide-containing powder is subjected to a heat treatment to 400° C., pyrolysis residues derived from the pitch are present on the surfaces. The copper oxide-containing powder containing copper (I) oxide contains the pitch and/or the above organic substance such that a mass ratio of the pyrolysis residues present after the heat treatment to the copper (I) oxide is 0.025 to 0.060. Further, the copper oxide-containing powder containing copper (II) oxide contains the pitch and/or the above organic substance such that a mass ratio of the pyrolysis residues present after the heat treatment to the copper (II) oxide is 0.050 to 0.120. In the heat treatment to 400° C., the copper oxide-containing powder is heated to 400° C. at a temperature increase rate of 10° C./min with a starting temperature of 25° C. in a nitrogen atmosphere.

The pitch is a mixture mainly based on relatively heavy organic substances resulting from distilling of tar obtained by dry distillation of organic substances, and examples of the pitch includes coal-tar pitch, oil pitch, or synthetic pitch, and the like.

If there are a few pyrolysis residues from the pitch after the heat treatment to 400° C., the copper sintered body cannot be obtained because the pitch is too less than copper oxide so that there is copper oxide which is not reduced to copper even if it is fired at a temperature higher than 400° C. On the other hand, if there are large amounts of pyrolysis residues from the pitch present after the heat treatment to 400° C., the copper oxide is reduced to copper because there is too much pitch with respect to copper oxide, but pyrolysis residues from the pitch will remain. The pyrolysis residues mainly consist of carbon and inhibits contact and sintering between copper particles. From this point of view, the mass ratio of the pyrolysis residues from the pitch present after the heat treatment to 400° C. to copper oxide is preferably 0.025 to 0.045 with respect to copper (I) oxide for the copper oxide-containing powder containing copper (I) oxide, and is preferably from 0.050 to 0.090 with respect to copper (II) oxide for the copper oxide-containing powder containing copper (II) oxide.

In addition, for copper (II) oxide, the valence of copper to be reduced is twice that of copper (I) oxide. Therefore, for the copper oxide-containing powder containing copper (II) oxide, it is theoretically believed that by allowing the amounts of copper oxide and pitch to be twice those in the case of the copper oxide-containing powder containing copper (I) oxide, the copper (II) oxide can be sufficiently reduced and the remaining of the pyrolysis residues from the pitch can be suppressed.

The copper oxide-containing powder may contain the pitch and be a mixture of the pitch and copper oxide before being subjected to the above heat treatment to 400° C. In this case, the mass ratio of the pitch to copper (I) oxide contained in the copper oxide-containing powder is preferably 0.050 to 0.090, more preferably 0.050 to 0.070. Furthermore, the mass ratio of the pitch to copper (II) oxide contained in the copper oxide-containing powder is preferably 0.100 to 0.180, more preferably 0.100 to 0.140. If the mass ratio of the pitch to copper oxide is too small, the reduction of copper oxide to copper will be insufficient, and if it is too large, excess pitch pyrolysis residues will remain even if the copper oxide is completely reduced to copper, so that a highly conductive sintered body cannot be obtained.

Alternatively, prior to the above heat treatment to 400° C., the copper oxide-containing powder may not contain the pitch, but it may contain at least one organic substance that produces the pitch by the heat treatment and may be a mixture of the organic substance and copper oxide. The heat treatment that produces the pitch can be performed under conditions of maintaining the temperature at 200° C. for 10 minutes or more in an inert atmosphere. Examples of the above organic substance include polyvinyl chloride, polyvinylidene chloride, polyvinylidene fluoride, polyvinyl alcohol, naphthalene, and methylnaphthalene. If such an organic substance is contained in the copper oxide-containing powder, the pitch will be generated in the middle of heating during sintering, and as described above, the disappearance of pyrolysis residues occurs due to reduction of copper oxide to copper and conversion to carbon monoxide, carbon dioxide, and the like. In this case as well, the copper sintered body can be effectively formed by firing in a non-reducing atmosphere. The copper oxide-containing powder may contain predetermined amounts of the pyrolysis residues derived from the pitch upon the heat treatment to 400° C., regardless of whether it contains the pitch prior to the heat treatment to 400° C. However, from the viewpoint of further reducing the amounts of gases generated during firing, it is preferable that the copper oxide-containing powder contains the pitch rather than the above organic substance prior to the above heat treatment to 400° C.

Oxidation of the copper oxide-containing powder containing the pitch and the above organic substance is effectively suppressed by the pitch and the above organic substance so that the predetermined amounts of the pyrolysis residues derived from the pitch is present after the heat treatment to 400° C. Therefore, the cuprous oxide-containing powder according to this embodiment has a high antioxidant ability.

When analysis of the copper oxide-containing powder using a time-of-flight mass spectrometer (TOF-MS) prior to the above heat treatment to 400° C. indicates that 50% by mass or more of the components thus detected is a mixture of substances having a molecular weight of 100 to 10,000, it can be considered that the copper oxide-containing powder contains the pitch. Typically, the pitch often contains 95% by mass or more of a mixture of substances having a molecular weight of 100 to 10,000 when analyzed by TOF-MS.

To determine the mass ratio of the pitch to copper oxide in the copper oxide-containing powder before or after the heat treatment to 400° C., it is suitable that the copper oxide-containing powder is identified by X-ray diffraction in addition to the TOF-MS measurement as described above, or the elemental composition is determined by combining X-ray fluorescence analysis, a combustion method, an ICP method and the like.

The above pitch preferably has a softening point of 200° C. or less. High softening point pitch having a softening point more than 200° C. has a high viscosity and must be mixed at a high temperature, so that there is a risk of deteriorating workability due to the generation of toxic gases, oxidation/alteration and ignition of pitch components.

The softening point of the pitch can be measured using a commercially available testing machine in accordance with JIS K2425 (2006).

### (Particle Size)

A particle size calculated from a BET specific surface area of the copper oxide-containing powder is preferably 0.1 μm to 10.0 μm. The particle size is more preferably 0.1 μm to 2.0 μm. If the particle size is larger, it may be difficult to reduce the copper oxide-containing powder to its inside. If the particle size is smaller, there is a possibility that the mixing state of the copper oxide-containing powder and a small amount of pitch or its pyrolysis residues tends to be non-uniform.

The particle size of the copper oxide-containing powder can be calculated from the BET specific surface area value using the following equation:

D=6/(ρ×SSA)

in which D is an average particle size, ρ is a true density, and SSA is the BET specific surface area of the copper oxide-containing powder.

The BET specific surface area (SSA) is measured in accordance with JIS Z8830: 2013 after degassing the copper oxide-containing powder in a vacuum at a temperature of 70° C. for 5 hours, using BELSORP-mini II from Microtrac Bell.

### (Conductive Paste)

The copper oxide-containing powder described above can be used for a conductive paste. The conductive paste contains the above copper oxide-containing powder, a binder resin, and a solvent.

Examples of the binder resin include cellulose resins, acrylic resins, alkyd resins, polyvinyl alcohol resins, polyvinyl acetals, ketone resins, urea resins, melamine resins, polyester, polyamide, and polyurethane. Examples of the solvent that can be used herein include alcohol solvents (e.g., one or more selected from the group consisting of terpineol, dihydroterpineol, isopropyl alcohol, butyl carbitol, terpineloxyethanol, and dihydroterpineloxyethanol), glycol ether solvents (e.g., butyl carbitol), acetate solvents (e.g., one or more selected from the group consisting of butylcarbitol acetate, dihydroterpineol acetate, dihydrocarbitol acetate, carbitol acetate, linaryl acetate, and terpinyl acetate), ketone solvents (e.g., methyl ethyl ketone), hydrocarbon solvents (e.g., one or more selected from the group consisting of toluene and cyclohexane), cellosolves (e.g., one or more selected from the group consisting of ethyl cellosolve, and butyl cellosolve), and diethyl phthalate or propionate solvents (e.g., one or more selected from the group consisting of dihydroterpinyl propionate, dihydrocarbyl propionate, isobornyl propionate).

When such a conductive paste is used for producing low-temperature co-fired ceramic (LTCC) substrates or multilayer ceramic chip capacitors (MLCCs), ceramic powder (green sheets) and the conductive paste may be alternately laminated and then fired simultaneously to form wiring of the copper sintered body between ceramic layers (co-firing method). Furthermore, the wiring of the copper sintered body may be formed by applying and firing the conductive paste after sintering the ceramic (post-firing method).

Here, in the conductive paste according to the embodiment, the pitch in the copper oxide-containing powder is thermally decomposed at the beginning of the firing process, and about half of the mass of the pitch is converted to pyrolysis residues. Further heating at an elevated temperature causes the pyrolysis residues to reduce the copper oxide in the copper oxide-containing powder to copper and disappear as carbon monoxide, carbon dioxide, and the like. As a result, sintering progresses and highly conductive copper wiring can be effectively formed.

The firing process allows for firing in a non-reducing atmosphere that does not contain a reducing agent such as hydrogen. This is because copper oxide can be reduced to copper through the reaction of the pyrolysis residues derived from the pitch with copper oxide. Therefore, it is advantageous in terms of costs since it does not require any explosion-proof equipment.

### (Production Method)

In order to obtain the copper oxide-containing powder as described above, it can be produced by preparing a powder containing copper oxide (copper (II) oxide powder, copper (I) oxide powder, copper powder containing copper oxide), and mixing the powder with the pitch and/or at least one organic substance that produces the pitch through the heat treatment, and optionally heating it.

For mixing (coating) with the pitch and/or the organic substance, it is preferable to use a blade type kneader or a roll type kneader. Amounts of the powder containing copper oxide and the pitch and/or the organic substance that produces the pitch through the heat treatment introduced into the kneader are adjusted as needed, such that the mass ratio of pyrolysis residues derived from the pitch to copper oxide after the heat treatment to 400° C. is in the predetermined range as described above.

During the mixing, it is necessary to heat it to a temperature equal to or higher than the softening point of the pitch, and preferably to heat it to a higher temperature by about 30° C. to 100° C. than the softening point, in order to lower the viscosity of the pitch. The mixing and kneading at a sufficiently high temperature allow the powder containing copper oxide to be uniformly mixed with the pitch and/or the organic substance that produces the pitch by heating.

After mixing the copper oxide powder with the pitch and/or the organic substance, the resulting mixed powder (pre-heating powder) may be heat-treated to 400° C., if necessary. In this case, the pitch and/or the organic substance is thermally decomposed by the heat treatment, and a copper oxide-containing powder containing pyrolysis residues derived from the pitch is obtained. When such a copper oxide-containing powder is included in a conductive paste and sintered, the carbon disappears while reducing the copper oxide to copper, and sintering progresses smoothly to form a copper sintered body.

The powder containing copper oxide used for the coating can be commercially available, but it can also be produced as described below.

The copper (I) oxide powder can be produced, for example, from a copper sulfate solution containing reducing sugar and alkali. Specifically, as an example, copper sulfate is added to a solvent such as pure water, and the resulting mixture is heated to 50° C. to 90° C., and preferably stirred at 50 rpm to 1000 rpm to obtain a copper sulfate solution. The reducing sugar such as glucose, fructose, glyceraldehyde, lactose, arabinose, and maltose is added thereto. It should be noted that although sucrose itself is not the reducing sugar, invert sugar produced by hydrolyzing sucrose can also be used as the reducing sugar. If necessary, denaturation inhibitors, specifically, for example, gum arabic, dextrin and other polysaccharides, glue or collagen peptides may be added. Then, an alkali is added dropwise to the copper sulfate solution, and the pH of the copper sulfate solution is maintained in a range of, for example, 8 to 11, to cause a reaction. The maintaining time of the pH is, for example, 0.1 to 10 hours.

Subsequently, washing with pure water, solid-liquid separation by decantation, and the like, are performed to obtain the copper (I) oxide powder.

The copper powder containing copper oxide can be produced, for example, by dry or wet heating of copper powder to oxidize the surface of the copper powder.

### EXAMPLES

Next, the copper oxide-containing powder as described above was experimentally produced and the effects thereof were confirmed, as described below. However, the descriptions herein are merely illustrative and are not intended to be limited thereto.

### (Production Method)

A copper (I) oxide powder having a BET specific surface area of 2.3 m²/g was prepared and coated with pitch. Specifically, for the coating, 500 g of copper (I) oxide powder and a predetermined amount (25 g to 50 g) of pitch were introduced into a blade-type kneader, and once the temperature increase to 150° C. was completed, kneading was carried out for one hour to produce a copper oxide-containing powder whose surface was coated with the pitch. As the pitch, PK-QL manufactured by JFE Chemical Co., Ltd. was used, and as the copper oxide powder, commercially available copper (I) oxide powder (50% particle size D50 by laser diffraction method is about 2.5 μm) was used. The softening point of the pitch is 74 to 80° C. The BET specific surface area of the copper oxide-containing powder was 0.8 to 0.9 m²/g, and the particle size calculated from the BET specific surface area was 1.2 μm.

In Comparative Example 1 and Examples 1 to 5, the amount of the pitch introduced into the blade type kneader was varied to obtain copper oxide-containing powders with different amounts of the pitch attached to the surfaces as shown in Table 1.

### (Thermogravimetry (TG))

For each of the copper oxide-containing powders according to Comparative Example 1 and Examples 1 to 5, a sample (35±5 mg) was placed in an alumina pan, the sample weight was measured using a balance that could have the minimum display of 0.1 mg, and the sample was set on a balance of a thermogravimeter (STA2500 Regulus manufactured by NETZSCH). The sample chamber was then sealed and evacuated, and gas replacement was performed by flowing an atmospheric gas at a flow rate of 500 mL/min for 10 minutes or more, and measurement was started. The measurement conditions were as follows: a measurement start temperature: 25° C.±10° C., an attainment temperature: 1000° C., a temperature increase rate: 10° C./min, and an atmospheric gas used: nitrogen.

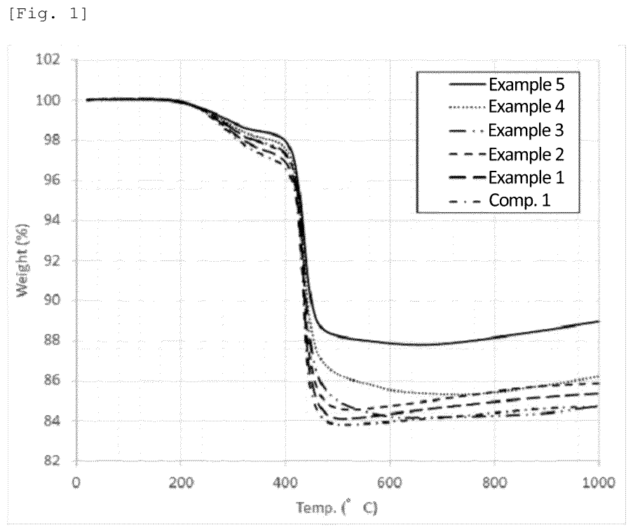

As a result, the graph shown in FIG. 1 was obtained. It is found from FIG. 1 that the mass of the copper oxide-containing powder gradually decreases up to about 400° C. This would be due to volatilization of components other than carbon in the pitch. On the other hand, when the temperature exceeds 400° C., the mass decreases rapidly, and it is assumed that reduction of copper (I) oxide to copper occurs here.

### (Thermomechanical Analysis (TMA))

For each of the copper oxide-containing powders according to Comparative Example 1 and Examples 1 to 5, a sample (300±20 mg) was placed in a φ5 cylindrical mold and compressed with a hydraulic press (Mini Lab Press manufactured by Labonect, Ltd.) to produce a pellet. The weight, diameter, and height of the pellet were measured, and the density of the pellet was calculated. The weight of the pellet was measured using a balance that could have the minimum display of 0.1 mg, and the diameter and height of the pellet were measured using a digital caliper that could have the minimum display of 1 μm. A sample pellet having a pellet density of 3.80±0.05 g/cm³ was set in a sample chamber of a thermomechanical analyzer (TMA4000SE manufactured by NETZSCH). The sample holder and detection rod used were made of quartz. After the sample chamber was sealed and evacuated, gas replacement was performed by flowing an atmospheric gas at a flow rate of 500 mL/min for 10 minutes or more, and measurement was started. The measurement conditions were as follows: a measurement start temperature: 25° C.±10° C., a load: 98 mN, an attainment temperature: 1000° C., a temperature increase rate: 10° C./min, and an atmospheric gas used: nitrogen.

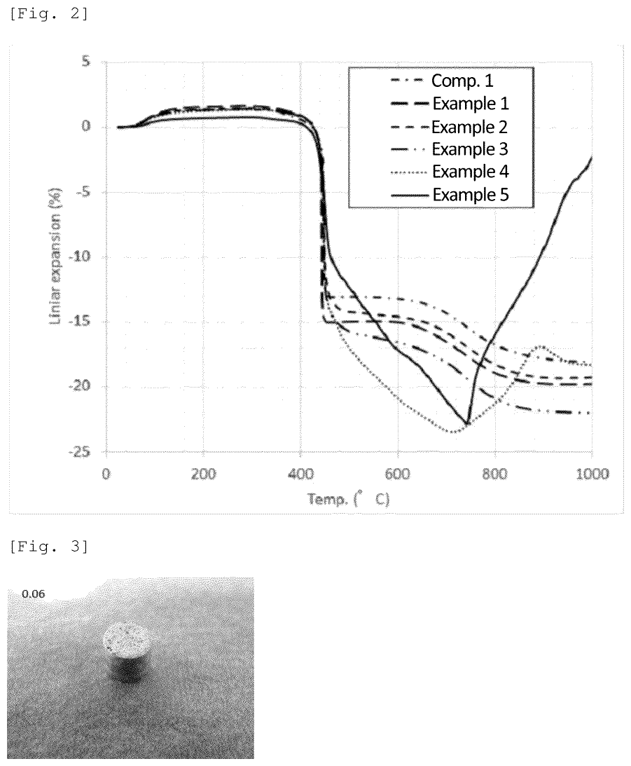

As a result, the graph shown in FIG. 2 was obtained. It should be noted that, in TMA, the particles making up the pellet are sintered as the temperature increases, and the cylindrical pellet is contracted in the height direction. The contraction rate may be referred to as a linear contraction. In FIG. 2, the vertical axis represents a linear expansion, and when this value is negative, it means the linear contraction.

Furthermore, using the maximum contraction in the above TMA, the maximum density was calculated assuming that the cylindrical pellet was contracted not only in the height direction but also in an isotropic direction. The results are shown in Table 1.

Comparative Example 1 had a lower maximum density. It is believed that, in Comparative Example 1, there was too much pitch attached to the surface of the copper oxide-containing powder, so that even though the copper (I) oxide was reduced to copper during firing, the carbon present around the copper particles obstructed the contact with the copper particles, and the sintering process did not proceed.

On the other hand, in each of Examples 1 to 5, the maximum density was higher, indicating that sintering was effectively performed. Furthermore, from the appearance of each sintered body of the pellet, it is believed that the copper (I) oxide was effectively reduced to copper. Especially, in Example 4, the maximum density of the pellet after heating was close to the density of copper, 8.96 g/cm³. A photograph of the pellet after heating in Example 4 is shown in FIG. 3. From FIG. 3, the pellet has a metallic luster and is recognized to be a copper sintered body.

TABLE 1

| | | | Mass Ratio | After 400° C. Heat Treatment | | | |
|---|---|---|---|---|---|---|---|
| | Copper (I) | | of Pitch to | Weight | Residual | Mass ratio of | Maximum |
| | Oxide | Pitch | Copper (I) | Loss | Pitch | Pyrolysis Residues to | Density |
| | [kg] | [kg] | Oxide | [%] | [g] | Copper (I) Oxide | [g/cm\hat{ }3] |
| Comp. 1 | 1 | 0.10 | 0.100 | 3.4% | 62.6 | 0.063 | 6.56 |
| Ex. 1 | 1 | 0.09 | 0.090 | 3.1% | 56.3 | 0.056 | 7.08 |
| Ex. 2 | 1 | 0.08 | 0.080 | 2.7% | 50.4 | 0.050 | 7.08 |
| Ex. 3 | 1 | 0.07 | 0.070 | 2.7% | 41.6 | 0.042 | 8.06 |
| Ex. 4 | 1 | 0.06 | 0.060 | 2.4% | 34.5 | 0.035 | 8.53 |
| Ex. 5 | 1 | 0.05 | 0.050 | 2.0% | 28.5 | 0.029 | 8.23 |

### (Oxidation Resistance)

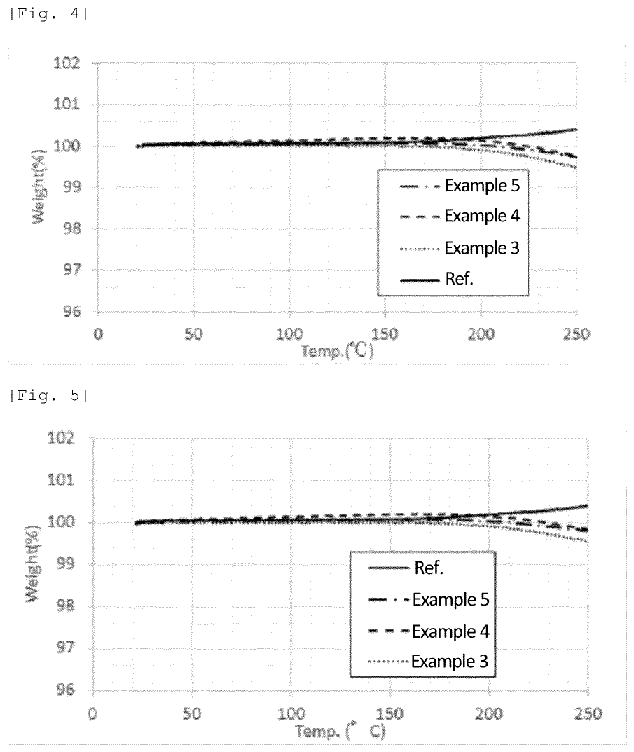

For each of the copper oxide-containing powder which was the copper (I) oxide powder that was not coated with the pitch (Reference Example) and the copper oxide-containing powders according to Examples 3 to 5, a change of weight with the temperature increase was measured in the same manner, with the exception that the atmospheric gas used in the thermogravimetry (TG) as described above was changed from nitrogen to air. As a result, the graph shown in FIG. 4 was obtained.

It is found from FIG. 4 that the weight of the copper oxide-containing powder according to Reference Example, which is not coated with the pitch, increases in the air as it is heated, which would indicate that it is oxidized. On the other hand, the weight of each of the copper oxide-containing powders according to Examples 3 to 5 decreases as they were heated. However, based on this result alone, there is also a possibility that the volatile contents of the pitch are simply decreased. Therefore, FIG. 5 shows a graph obtained by subtracting the volatile contents of the pitch obtained by subjecting only the pitch to the thermogravimetric measurement (TG) from the graph of FIG. 4.

As can be seen from FIG. 5, the weight of each of the copper oxide-containing powders according to Examples 3 to 5 decreases in the air even after subtracting the volatile contents of the pitch. This indicates that in each of the copper oxide-containing powders according to Examples 3 to 5, the decrease in weight due to reduction took place more preferentially than the increase in weight due to oxidation even in the air.

In view of the foregoing, according to the copper oxide-containing powder, it is possible to have an improved antioxidant ability and effectively form a copper sintered body by heating in a non-reducing atmosphere.

1. A copper oxide-containing powder comprising copper (I) oxide, wherein, when the copper oxide-containing powder is subjected to a heat treatment to 400° C., the copper oxide-containing powder comprises pyrolysis residues derived from pitch, in a mass ratio to copper (I) oxide of 0.025 to 0.060%.

2. A copper oxide-containing powder comprising copper (II) oxide, wherein, when the copper oxide-containing powder is subjected to a heat treatment to 400° C., the copper oxide-containing powder comprises pyrolysis residues derived from pitch, in a mass ratio to copper (II) oxide of 0.050 to 0.120%.

3. The copper oxide-containing powder according to claim 1, wherein the copper oxide-containing powder is a mixture of the pitch and copper (I) oxide, and the mass ratio of the pitch to the copper (I) oxide is 0.050 to 0.090.

4. The copper oxide-containing powder according to claim 2, wherein the copper oxide-containing powder is a mixture of the pitch and copper (II) oxide, and the mass ratio of the pitch to copper (II) oxide is 0.100 to 0.180.

5. The copper oxide-containing powder according to claim 1, wherein the copper oxide-containing powder is a mixture of at least one organic substance that generates the pitch through the heat treatment with copper oxide.

6. The copper oxide-containing powder according to claim 1, wherein a particle size calculated from a BET specific surface area is 0.1 μm to 2.0 μm.

7. The copper oxide-containing powder according to claim 1, wherein the pitch has a softening point of 200° C. or less.

8. The copper oxide-containing powder according to claim 1, comprising a copper oxide powder.

9. The copper oxide-containing powder according to claim 1, comprising a copper powder containing copper oxide.

10. The copper oxide-containing powder according to claim 1, wherein the copper oxide-containing powder is used in a firing process that performs heating in a non-reducing atmosphere.

11. A conductive paste comprising the copper oxide-containing powder according to claim 1, a binder resin, and a solvent.

12. A method for producing a copper oxide-containing powder comprising pyrolysis residues derived from pitch, the method comprising the steps of:
preparing a copper oxide powder, and at least one of pitch and at least one organic substance for generating the pitch by a heat treatment;
mixing the copper oxide powder with at least one of the pitch and the organic substance to obtain a pre-heating powder; and
subjecting the pre-heating powder to a heat treatment to 400° C. to obtain a copper oxide-containing powder comprising pyrolysis residues derived from the pitch.
